(19) United States
(12) Patent Application Publication
(10) Pub. No.: US 2005/0219613 A1
(43) Pub. Date: Oct. 6, 2005

(54) Network print service system and network print service method

(75) Inventor: Takuya Hirashima, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/094,240

(22) Filed: Mar. 31, 2005

(30) Foreign Application Priority Data
Mar. 31, 2004 (JP) 2004-104853

(51) Int. Cl. G06F 15/00

(52) U.S. Cl. 358/1.15

(57) ABSTRACT

The network print service system includes a distributing terminal which transmits image data of a first image for providing a print as a gift, one or more receiving terminal which transmits order information for ordering the print of a second image selected from the first image in order to receive the print for free as the gift, a gift service center which receives the image data transmitted from the distributing terminal and accepts the order information of the second image transmitted from the receiving terminal, a print output unit which outputs the print of the second image in accordance with the order information accepted in the gift service center and a print delivery unit which delivers the output print of the second image to an image receiving user who has transmitted the order information from the receiving terminal.

This application claims priority on Japanese patent application No. 2004-104853, the entire contents of which are hereby incorporated by reference.

### BACKGROUND OF THE INVENTION

The present invention relates to a network print service system and a network print service method. More specifically, the present invention relates to a network print service system which enables each of image receiving users specified by an image distributing user to directly transmit a print order for a desired image that was transmitted for a print gift from an image distributing user terminal and stored on storage means such as a server in a gift service center on a network, from an image receiving user terminal of each of the image receiving users to the gift service center, without any troublesome procedures such as registration for payment of the printing fee, in a network print gift service in which print output is performed for the images stored on the storage means in accordance with an instruction from the image receiving user terminal operated by the image receiving user to receive the print gift, and a network print service method using the network print service system.

Conventionally, there is known as a type of digital photographing service a network print service in which user's image data is stored on a server of a service provider (service center) and a print order is received via a network such as the Internet (Fujicolor Internet Service from FUJI PHOTO FILM CO., LTD. and the like).

In this service, for example, image data of a user is stored on a server of a service provider via the Internet, and when another user wants print output for a specified image in the stored image data, he/she requests the service provider to output a print of the specified image. The user can obtain the output print by asking the service provider to deliver it or directly visiting a predetermined place such as a nearby photo lab.

In the network print service described above, it is possible to make open to the public on the network an image of the image data stored on the server of the service provider, which enables other users than the user whose image data is stored on the server to connect to the network to see the image open to the public. The other users can also make a print output request for a predetermined image open to the public to the service provider and thus receive the output print.

Through the use of the network print service, one user (image distributing user) makes open to the public on the network images on which plural users (image receiving users) are shot as the subject (e.g., images of various photos in a wedding ceremony, a party, a group tour, various conferences or meetings and various competitions, and in particular an image of a group photo) and the image receiving users are informed of the address of the site on which the images can be found. As a result, the image receiving users can access the network to check the images on the site, request a service provider through the network to output prints of images they selected from among the images on the site, and receive the prints output in response to the request.

Provision of the network print service enables the service provider to directly receive print output requests for an image of the stored image data not only from the image distributing user whose image data is stored but also other image receiving users, so that the service provider will have increased opportunities to receive the print output requests.

This network print service is also advantageous in that the image distributing user who tries to provide prints to several image receiving users does not need to confirm the desire of the image receiving users when requesting the service provider to output prints, which may lead to more frequent use of the network print service by the image distributing user. This is advantageous for the service provider.

In the network print service, an order is placed with a service provider via a network an indefinite number of persons can easily access.

Thus, the service provider needs to collect, without fail, the network print service fee from a user of the network print service that has accessed the network. Thus, the service user must transmit to the service provider information on the number of an image to be printed and the number of prints, the destination of the prints where the service user can receive the prints directly or via a photo lab. The service user must also register a consideration payment method such as withdrawal from an account of a financial institution such as a bank for credit card payment or the like, transfer from a financial institution such as a bank or a convenience store, a check method and a settlement method, as well as personal information such as card information, account information, and information on reception of a bill.

In the network print service, a print obtained by actually outputting image data as a hard copy image is provided to a user. Compared with electronic data (image data) download service where image data is stored on predetermined storage means on the network, a large number of users access the image data via the network and download the data to acquire the image data, the network print service requires additional costs from order receipt to delivery of prints including material costs, labor costs and distribution costs. In such a network print service, it is important to save unnecessary costs caused by false orders from an indefinite number of persons.

In order to ensure the reliability of print request information and collection of a service fee, it is necessary to identify a print requester. Thus, a service provider makes users perform user registration with which the users can request print output, and assigns authentication information only to the users who performed the user registration in order to limit the service use to the users who have acquired the authentication information. The users who have acquired the authentication information are free to instruct storage or deletion of image data onto or from predetermined storage means on the network, instruct to make the stored image data open to the public, or order printing of the image data.

A user who has not performed user registration can also request a print order or delivery by newly performing user registration and acquiring authentication information. However, the user registration has been cumbersome and time-consuming.

The user registration involves inputting some personal information as mentioned above, so that some users may hesitate to perform user registration. A user that has not performed user registration cannot request print output even if the user wishes to order a print. As a result, the service provider loses some chances of receiving print requests.

### SUMMARY OF THE INVENTION

An object of the invention is to provide a network print service system which allow a print of an image owned by an image distributing user to be presented as an electronic gift to an image receiving user and which allow an image receiving user who has received at the terminal of the image receiving user the electronic print gift from the terminal of the image distributing user to access the service provision means of a service provider on a network to directly place a print order for a desired image in images owned by the image distributing user and stored on the storage means such as a server and receive the ordered print, without making cumbersome user registration via the terminal.

Another object of the present invention is to provide a network print service method using the network print service system.

In order to attain the object described above, the first aspect of the invention provides a network print service system comprising an image distributing user terminal which transmits image data of at least one first image for providing at least one print as a gift, at least one image receiving user terminal which transmits order information for ordering at least one print of at least one second image in order to receive the at least one print for free as the gift, a gift service center which receives the image data of the at least one first image transmitted from the image distributing user terminal and accepts the order information of the at least one print of the at least one second image selected from the at least one first image transmitted from the image receiving user terminal, print output means which outputs the at least one print of the at least one second image in accordance with the order information accepted in the gift service center, and print delivery means which delivers the at least one print of the at least one second image output from the print output means to an image receiving user who has transmitted the order information from the image receiving user terminal, wherein the gift service center comprises acceptance means which accepts image data of each original image of the at least one first image to be provided as the gift transmitted from the image distributing user terminal as well as accepts registration information necessary for providing each original image as the gift, storage means which stores each original image of the at least one first image accepted at the acceptance means from the image distributing user terminal, order-related information transmission means which transmits, in return for the registration information registered by the acceptance means, order-related information including print order permission information to permit a print order of the at least one first image stored on the storage means to the image distributing user terminal, in a form distributable to the image receiving user terminal, order instruction means which accepts and verifies the print order permission information transmitted from the image receiving user terminal which has received the order-related information distributed from the image distributing user terminal, accepts the order information of the at least one second image selected from the at least one first image stored on the storage means, and instructs print output of the selected at least one second image according to the order information to the print output means, delivery instruction means which instructs a delivery method for delivering the at least one print of the at least one second image output by the print output means to the image receiving user, and billing means which charges the image distributing user with costs of a print gift service including output and delivery of the at least one print of the selected at least one second image in accordance with an order of the image receiving user.

Preferably, the acceptance means accepts, as the registration information, an upper limit of the number of prints accepted from the image receiving user, a period when the order from the image receiving user is accepted and payment-related information on the costs, and authenticates billing information on the image distributing user in accepting the payment-related information, and the billing means charges the image distributing user with the costs for the print gift service and makes settlement in accordance with the payment-related information and the authenticated billing information.

Preferably, the order-related information transmission means returns the order-related information to the image distributing user terminal, and the order-related information returned from the gift service center to the image distributing user terminal is transmitted as an e-mail from the image distributing user terminal to the image receiving user terminal of the image receiving user to whom the at least one second image is to be presented as the gift.

Preferably, the order-related information includes a timed-release encryption key, an ordering program, image identification information on the at least one image provided as the gift and a corresponding thumbnail image.

Preferably, the ordering program of the order-related information received as the e-mail from the image distributing user terminal is activated at the image receiving user terminal, wherein order information including selection of a second image to be received as the gift, the number of prints, a print size, and the delivery method is input from an order screen displayed, and the print order is made as an order e-mail by the image receiving user.

Preferably, the ordering program activated at the image receiving user terminal automatically transmits, as the order e-mail, the encryption key, the image identification information and the order information to the gift service center.

Preferably, the ordering program automatically erases the encryption key, once it has automatically transmitted the order e-mail to the gift service center.

Preferably, the order instruction means of the gift center receives the encryption key, the image identification information and the order information from the image receiving user terminal, accepts the order information where the encryption key and the image identification information are matched, and instructs output of the at least one print of the selected at least one second image according to the order information to the print output means, and the print output means uses the image data of each original image of the at least one first image stored on the storage means to output the at least one print of the selected at least one second image in accordance with the order information.

Preferably, the image distributing user terminal comprises a first image distributing user terminal which transmits the image data of each original image of the at least one first image provided as the gift as well as the registration information to the service center and performs acceptance at the acceptance means and a second image distributing user terminal which receives the order-related information from the gift service center by way of the order-related information transmission means, and distributes the at least one first image to the image receiving user terminal of the image receiving user to whom the at least one second image is to be presented as the gift.

Preferably, the second image distributing user terminal is one specified in the registration information which the first image distributing user terminal transmits to the service center, or one which has received service authentication information from the first image distributing user terminal which has received the service authentication information to authenticate acceptance of the print gift service from the acceptance means by way of acceptance of the registration information, and which has accessed the acceptance means of the service center, where the service authentication information is verified.

Preferably, the acceptance means accepts, as the registration information, at least an upper limit of the number of prints accepted as the order from the image receiving user and a period when the order is accepted from the image receiving user, wherein the order-related information transmission means accepts the payment-related information on the costs as the registration information when returning the order-related information to the second image distributing user terminal, and authenticates billing information on the second image distributing user in accepting the payment-related information, and the billing means charges the second image distributing user with the costs for the print gift service and makes settlement in accordance with the payment-related information and the authenticated billing information.

In order to attain another object described above, the second aspect of the invention provides a network print service method comprising, in response to an instruction from a predetermined image distributing user, transmitting image data of each original image of at least one first image to provide at least one print as a gift and registration information necessary for providing at least one first image as the gift from an image distributing user terminal to a gift service center, in return for the registration information registered, storing on storage means image data of each original image of at least one first image accepted at the gift service center as well as transmitting order-related information including print order permission information to permit a print order of the at least one first image stored on the storage means from the gift service center to the image distributing user terminal, in a form distributable to an image receiving user terminal which can receive the at least one print for free as the gift, in order to provide the at least one print as the gift, transmitting the order-related information including the print order permission information from the image distributing user terminal to at least one image receiving user terminal, in order to receive the at least one print for free as the gift, transmitting the print order permission information and order information to order the at least one print for free as the gift of selected at least one second image selected from the at least one first image stored on the storage means from the image receiving user terminal to the gift service center, accepting and verifying the print order permission information transmitted from the image receiving user terminal, and accepting the order information of the selected at least one second image, outputting the at least one print of the at least one second image in accordance with the accepted order information, delivering the at least one print of the output at least one second image from the image receiving user terminal to an image receiving user who has transmitted the order information, and charging the image distributing user with costs of a print gift service including output and delivery of the at least one print of the selected at least one second image in accordance with the order of the image receiving user.

According to the invention, without making complicated and time-consuming tasks including user registration with the service provider and cumbersome verification task for authentication as well as input of personal information, at least one image receiving user who has received at the terminal of the image receiving user an electronic print gift (print receiving right) of images owned by and sent from an image distributing user can place from the image receiving user terminal, a print order for a desired image in images owned by the image distributing user and stored on predetermined storage means on a network, directly and without restriction, whenever the image receiving user desires.

According to the invention, it is possible to present a print of an image owned by an image distributing user to a specific image receiving user alone as an electronic gift, without increasing complicated tasks including user registration of an image distributing user with the service provider and cumbersome verification task for authentication. As a result, the image receiving user who has received an electronic gift can place a print order for an image owned by the image distributing user with the service provider whenever the image receiving user desires and receive the print free as a gift. Thus, the image distributing user does not need to collect the print orders the image receiving users placed for the image distributing users images or to deliver the output prints to the respective image receiving users.

Thus, according to the invention, the image distributing user can present an electronic print gift to only at least one image receiving user. This prevents false orders from an indefinite number of persons and eliminates the payment for unnecessary costs. The image distributing user can readily make a request for an electronic print gift service. The image receiving user can directly place an order for a desired image print with the service provider without making complicated and time-consuming tasks including user registration and input of personal information. This is also advantageous for the service provider that can have increased opportunities of receiving print orders.

### BRIEF DESCRIPTION OF THE DRAWINGS

FIG. 1 is an overall view of a network print service system according to an embodiment of the invention;

FIG. 2 illustrates the function block of a gift service center which is a site constituting the network print service system shown in FIG. 1;

FIG. 3 illustrates the function blocks of an image distributing user terminal and an image receiving user terminal which are sites constituting the network print service system shown in FIG. 1;

FIG. 4 is a flowchart showing a flow of a network print service method according to an embodiment of the invention;

FIG. 5 shows an exemplary screen presented on a display of the image distributing user terminal in the network print service method according to the invention;

FIG. 6 shows another exemplary screen presented on the display of the image distributing user terminal in the network print service method according to the invention;

FIG. 7 shows still another exemplary screen presented on the display of the image distributing user terminal in the network print service method according to the invention; and

FIG. 8 shows an exemplary screen presented on a display of the image receiving user terminal in the network print service method according to the invention.

### DETAILED DESCRIPTION OF THE INVENTION

The network print service system and the network print service method according to the invention are detailed below based on preferred embodiments shown in the attached drawings.

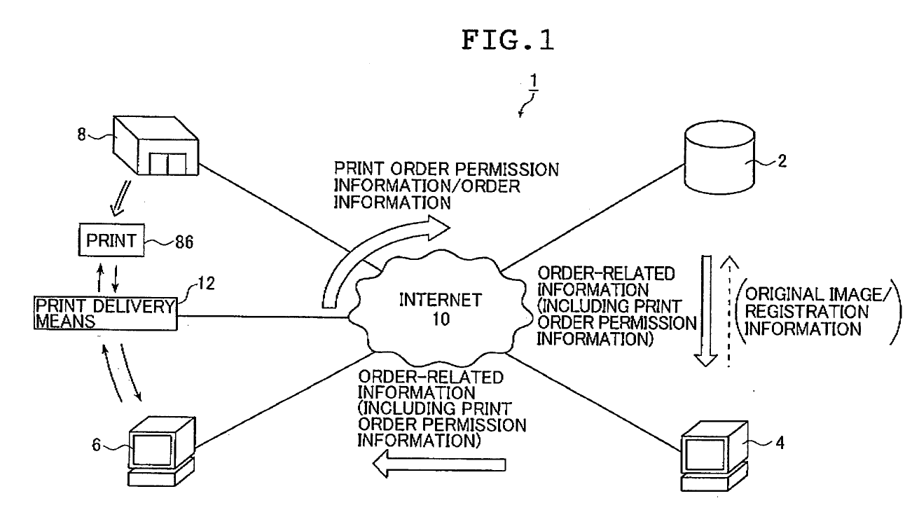

FIG. 1 is a schematic overall view of a network print service system according to an embodiment of the invention. As shown in FIG. 1, a network print service system (hereinafter referred to as a service system) 1 is configured so that a gift service center 2 that accepts a service provision request from a user and provides network print service, an image distributing user terminal 4, an image receiving user terminal 6, and a small-sized photo lab 8 as a print output means where prints are output in accordance with an instruction from the gift service center 2 exchange information with each other via the Internet 10. On top of the components connected to the Internet 10, the network print service system 1 comprises print delivery means 12 for delivering a print output from the photo lab 8.

According to an instruction from an image distributing user who pays for print gift service provided by the gift service center 2 which will be described later, the image distributing user terminal 4 transmits to the gift service center 2 at least one image for providing a print as a gift (hereinafter referred to as a gift image) and registration information necessary for an image to be handled as a gift, and in return for the registration information, receives order-related information which includes a time-limited encryption key as print order permission information and which is transmitted from the gift service center 2 in a distributable form. The image distributing user terminal 4 then distributes print order permission information included in the order-related information to predetermined image receiving user terminals 6.

According to an instruction from a predetermined image receiving user specified by the image distributing user, order information which includes desired conditions as specifying gift images whose printing is desired and the desired number of prints, is transmitted from the image receiving user terminal 6 to the gift service center 2 based on the print order permission information received from the image distributing user terminal 4. The image distributing user terminal 4 and the image receiving user terminal 6 will be described later in detail. In the invention, the number of the image receiving user terminals 6 is not particularly limited. Each of the image receiving user terminals 6 can place an image print order with the gift service center 2. The number of the image distributing user terminals 4 connected to the Internet 10 also is not particularly limited.

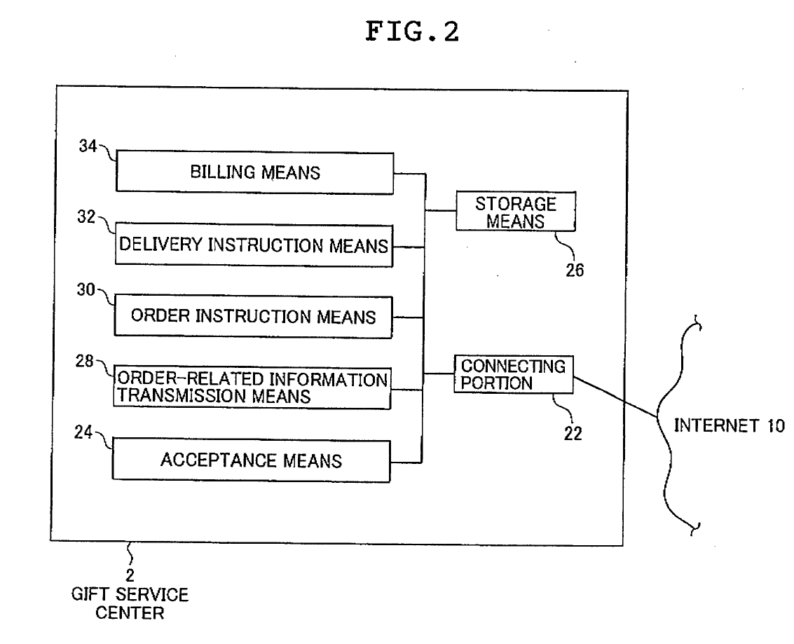

FIG. 2 illustrates the function block of the gift service center 2 which is a site constituting the network print service system 1 shown in FIG. 1. In response to an instruction from the image distributing user terminal 4 or image receiving user terminal 6 through access to the gift service center 2 via the Internet, the gift service center 2 provides network print service to a user operating each terminal. The gift service center 2 comprises a connecting portion 22, acceptance means 24, storage means 26, order-related information transmission means 28, order instruction means 30, delivery instruction means 32, and billing means 34.

As will be described later, each user accesses the gift service center 2 from the image distributing user terminal 4 or the image receiving user terminal 6 via the Internet 10 to give an instruction while viewing the web page screen on the image distributing user terminal 4 or the image receiving user terminal 6 (more specifically its display 4a or 6a), and the above-mentioned means operate in accordance with the instruction given by means of the so-called GUI (graphical user interface). The gift service center 2 is a computer which includes a CPU and a memory (these are not shown) and in which the respective portions function by means of software. In the network print service system of the invention, the gift service center 2 is not limited to the computer but may be a dedicated apparatus in which the respective portions are composed of dedicated circuits.

The connecting portion 22 is a portion which connects the Internet 10 to the gift service center 2 and through which exchange of data and information is performed with the image distributing user terminal 4, the image receiving user terminal 6, the photo lab 8, and the print delivery means 12.

The acceptance means 24 is a portion which accepts an original image for an image to be provided as a gift to an image receiving user (hereinafter referred to as a gift image) as well as accepts registration information necessary for providing the gift image as a gift to the image receiving user in response to an order made by the image receiving user. The registration information includes the upper limit of the number of prints for which the image receiving user can place an order, time limit for order receipt from the image receiving user, and payment-related information concerning the payment of the service fee. The payment-related information includes information which specifies a consideration payment method such as withdrawal from an account of a financial institution such as a bank for credit card payment or the like, transfer from a financial institution such as a bank or a convenience store, a check method and a settlement method, as well as information (billing information) which ensures that a service provider collects a print gift service fee from an image distributing user, such as card information and account information for payment of the service fee and information on the method of receiving a bill. The acceptance means 24 checks billing information transmitted from the image distributing user terminal 4 to make sure that the transmitted billing information identifies the image distributing user and collection of the service fee involves no problems, that is, authenticates the user's billing information.

The storage means 26 is an image database which stores a gift image transmitted from the image distributing user terminal 4 through access to the gift service center 2. The gift image is the original image of the image to be presented as a gift from the image distributing user to the image receiving user. The gift image is transmitted from the image distributing user terminal 4 via the Internet 10.

The order-related information transmission means 28 is a portion which transmits order-related information to the image distributing user terminal 4 in return for the registration information transmitted from the image distributing user terminal 4. The order-related information is transmitted via the Internet 10. The order-related information includes a time-limited encryption key as print order permission information which permits a print order for a gift image stored on the storage means 26, an ordering program to be described later, an image ID (image identification information) of the gift image and a thumbnail image of the gift image. The order-related information can be distributed from the image distributing user terminal 4 to the image receiving user terminals 6. In this embodiment, the order-related information is distributed from the image distributing user terminal 4 to the image receiving user terminals 6 via the Internet 10 as an electronic file as will be described later.

The order instruction means 30 is a portion which acknowledges the print order permission information included in the order-related information transmitted from the image receiving user terminal 6 which has received the order-related information transmitted from the image distributing user terminal 4, accepts the order information on the print output conditions and delivery conditions of a gift image selected by the image receiving user, and transmits to the print output means or the photo lab 8 the print instruction information which is information to instruct the print output conditions for the gift image selected in accordance with the order information. The order instruction means 30 may call the original image for the gift image selected by the image receiving user from the storage means 26 and transmit the original image and the print instruction information to the photo lab 8 via the Internet 10, or transmit the print instruction information alone to the photo lab 8.

The delivery instruction means 32 is a portion which instructs a method for delivering the print of a gift image output from the photo lab 8 to the image receiving user (hereinafter referred to as a delivery method) to the print delivery means 12 to be described later. Instruction of the delivery method is made based on the order information transmitted from the image receiving user terminal 6. That is, in case the order information transmitted from the image receiving user terminal 6 includes a method for delivering the output print to the image receiving user, the deliver instruction means 32 instructs the delivery method to the print delivery method 12 based on the order information. Instruction of the delivery method to the print delivery means 12 may be made based on the registration information transmitted from the image distributing user terminal 4. In this practice, a method for delivering the output print to the image receiving user is instructed in the registration information transmitted from the image distributing user terminal 4.

The billing means 34 is a portion which charges to the image distributing user for the service fee involved in outputting and delivering a print of a gift image in accordance with the order by the image receiving user (print gift service). The billing means 34 performs billing processing such as billing of the print gift service fee to the image distributing user terminal 4 and settlement therefor. The billing processing includes billing the image distributing user for the fee corresponding to the costs calculated based on the type and number of prints provided to the image receiving user in accordance with the order information, and receiving payment of the service fee from the image distributing user.

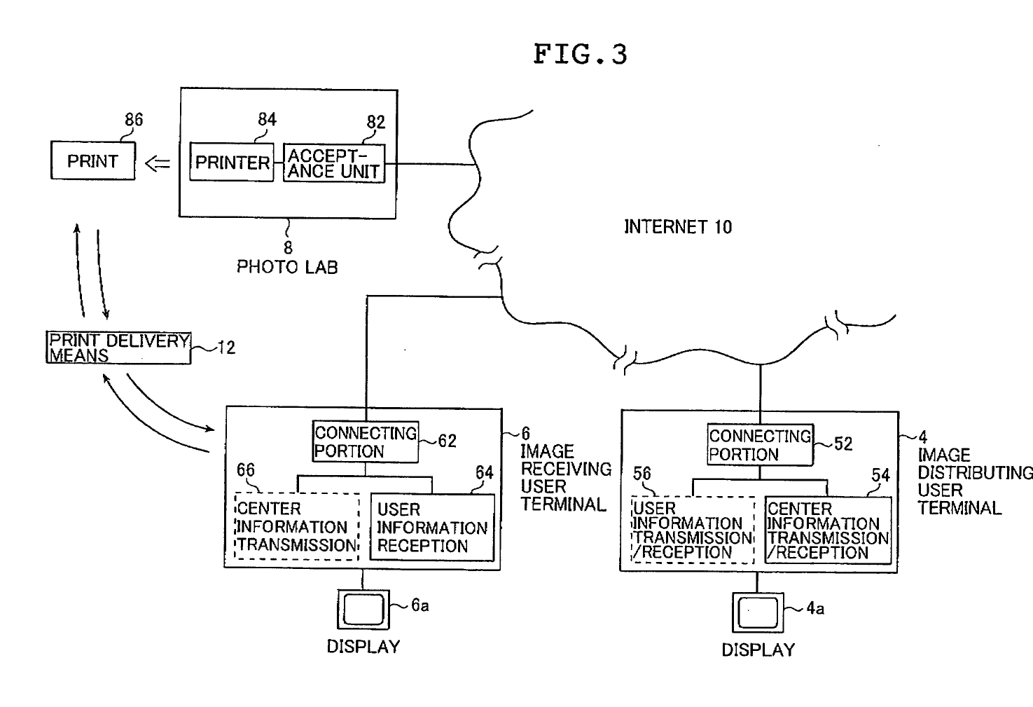

FIG. 3 is a block diagram schematically showing the respective sites constituting the network print service system 1 shown in FIG. 1 and particularly illustrates the functions of the image distributing user terminal 4 and the image receiving user terminal 6. The image distributing user terminal 4 is a personal computer including a browser application and a mail application and comprises a connecting portion 52 which is connected to the Internet 10 and through which exchange of information and data is performed with the gift service center 2 and the image receiving user terminal 6, center information transmission/reception means 54, and user information transmission/reception means 56. The center information transmission/reception means 54 is a browser application. When the image distributing user operates the image distributing user terminal 4 while viewing a web page screen displayed on the screen of the image distributing user terminal 4, the center information transmission/reception means 54 executes various processes via the connecting portion 22 such as transmission of the original image for the gift image to the gift service center 2, transmission of the registration information, and reception of the order-related information transmitted from the gift service center 2. The user information transmission/reception means 56 is a mail application and distributes the order-related information to the image receiving user terminals 6 as an e-mail when the image distributing user operates the image distributing user terminal 4 while viewing the mail application screen displayed on the screen of the image distributing user terminal 4. In the network print service system of the invention, the image distributing user terminal 4 is not limited to a computer but may be a dedicated apparatus including dedicated circuits to execute various functions such as transmission of the registration information to the gift service center 2 and transmission of the order-related information to the image receiving user terminals 6.

The image receiving user terminal 6 comprises a connecting portion 62 which is connected to the Internet 10 and through which exchange of information and data is performed with the gift service center 2 and the image distributing user terminal 4, user information reception means 64 which receives the order-related information transmitted from the image distributing user terminal 4, and center information transmission means 66 which transmits the print order permission information and print output order information to the gift service center 2.

The image receiving user terminal 6 is a personal computer including a mail application. The user information reception means 64 operates by means of this application. The order-related information received by the user information reception means 64 includes, as mentioned above, a time-limited encryption key, an ordering program to be described later, an image ID of a gift image, and a thumbnail image of the gift image. In the image receiving user terminal 6, the image receiving user activates an ordering program included in the order-related information and transmits the print order permission information and the order information based on the ordering program in accordance with his/her manipulation for inputting an instruction, while viewing the screen (more specifically the screen for the ordering program) represented on the display 6a of the image receiving user terminal 6. In the network print service system of the invention, the image receiving user terminal 6 is not limited to a computer but may be a dedicated apparatus composed of dedicated circuits.

The photo lab 8 refers to a predetermined photofinishing laboratory. The photo lab 8 comprises an acceptance unit 82 which receives print instruction information transmitted from the order instruction means 30 of the gift service center 2 and the original image for a gift image to be printed and issues a print instruction to a printer 84 to be described later based on the print instruction information, and the printer 84 which outputs as a print the original image transmitted from the acceptance unit 82 in accordance with the instruction from the acceptance unit 82.

The print delivery means 12 is a portion which delivers to the image receiving user a print 86 output in the photo lab 8 in accordance with the delivery method instructed by the delivery instruction means 32 of the gift service center 2. The print delivery means 12 may deliver the print 86 output from the printer 84 to the image receiving user by means of a predetermined delivery company, or deliver the print 86 to the image receiving user who has visited the photo lab 8. The print delivery means 12 has no particular limitation on the method of delivering the print 86 to the image receiving user.

The network print service system 1 shown in FIG. 1 shows a case where a service provider, a photofinisher and a delivery company execute the above functions as the gift service center 2, the photo lab 8 (print output means) and the print delivery means 12, respectively, and information is exchanged via the Internet 10. The network print service system 1 of the invention having the above configuration is capable of service provision even if the image distributing user terminal 4, the image receiving user terminal 6, the gift service center 2 and the photo lab 8 are apart from each other. The network print service system of the invention is not limited thereto but at least two of the service provider, photofinisher and delivery company may be a single firm. To be more specific, the service center 2 may be provided with one or both of the photo lab 8 and the print delivery means 12. Alternatively, the photo lab 8 may be incorporated with the print delivery means 12 apart from the service center 2.

An embodiment of the network print service method implemented in the network print service system 1 will be described below with reference to drawings and the functions of the respective portions of the system will be also described in detail.

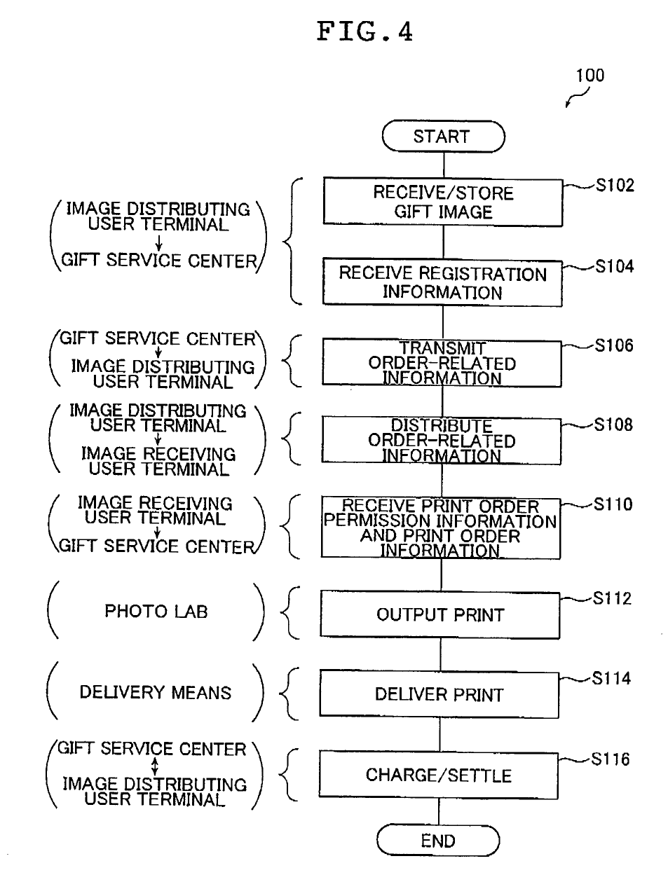

FIG. 4 is a flowchart 100 which shows the flow of network print service according to an embodiment of the network print service method of the invention. The gift service center 2 provides network print service shown in the flowchart 100 on condition that the image distributing user operating the image distributing user terminal 4 pays the service fee, such that the image receiving user at a predetermined image receiving user terminal 6 specified by the image distributing user terminal 4 can place an order for print output of a gift image stored on the image distributing user terminal 4 without any cumbersome registration procedure and obtain the print free.

In the network print service method of the invention, the image distributing user terminal 4 transmits a gift image to the gift service center 2. The gift service center 2 receives the gift image and stores it on the storage means 26 (step S102 in FIG. 4).

The image distributing user terminal 4 operated by the image distributing user who wishes to provide network print gift service accesses the gift service center 2.

A browser application running on the image distributing user terminal 4 is used to access a web site in the gift service center 2 from the image distributing user terminal 4. Each means in the gift service center 2 addresses a predetermined program of each web page file in the web site. These means are executed, as mentioned earlier, when the image distributing user operates the image distributing user terminal 4 while viewing the display on the image distributing user terminal 4. When the image distributing user accesses the gift service center 2 through the browser application of the image distributing user terminal 4, each means in the image distributing user terminal 4 is also executed by the operation of the image distributing user terminal 4 the image distributing user performs while viewing the screen of the browser application presented on the display of the image distributing user terminal 4.

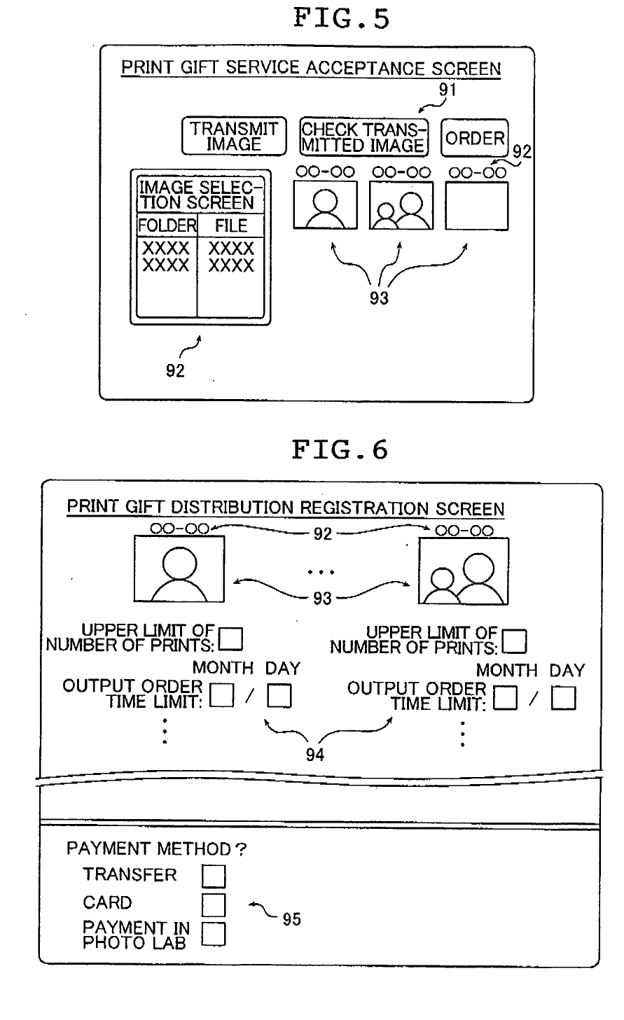

In response to the access from the image distributing user terminal 4 to the gift service center 2, the home page of the web site on the server of the service provider is presented on the display 4a of the image distributing user terminal 4. The home page corresponds to the acceptance means 24. In response to the access from the image distributing user terminal 4 to the web site of the service center 2, a print gift service acceptance screen shown in FIG. 5 appears on the display 4a. As shown in FIG. 5, the acceptance screen displays sub-menu selector buttons 91, of which the TRANSMIT IMAGE menu button is selected. When the TRANSMIT IMAGE menu button is selected, a screen 92 for selecting an image from among images stored on the image distributing user terminal 4 is displayed. When a desired gift image to be presented as a print to the image receiving user is selected, the gift image is transmitted to the gift service center 2 and stored on the storage means 26. The stored gift image is presented on the display screen as a thumbnail image 93 so that the image distributing user can confirm it. For each of the displayed thumbnail images 93, the image ID 92 of a gift image corresponding to each thumbnail image is displayed. The gift service center 2 stores the received gift images on the storage means 26.

When reception of the gift images in the gift service center 2 is finished, registration information is then transmitted from the image distributing user terminal 4 to the gift service center 2 (step S104). Reception of registration information is made as follows: First, the image distributing user operates the image distributing user terminal 4 to select the order menu button from among the sub-menu selector buttons 91 shown in FIG. 5. When the order menu button is selected, a print gift distribution registration screen shown in FIG. 6 is displayed, and then a list of thumbnail images of the gift images transmitted from the image distributing user terminal 4 and stored on the storage means 26 of the gift service center 2 is displayed. Each thumbnail image is provided with corresponding condition input boxes 94. It is possible to set, for each image data, the upper limit of the number of prints whose output can be ordered from one image receiving user terminal 6 and the period of time for which the print output order information can be accepted. On the screen, there are also displayed check boxes 95 that allow the image distributing user operating the image distributing user terminal 4 to select a method of paying the service fee, or other boxes. In this way, the image distributing user can designate from the image distributing user terminal 4 the payment method (which forms part of the payment-related information).

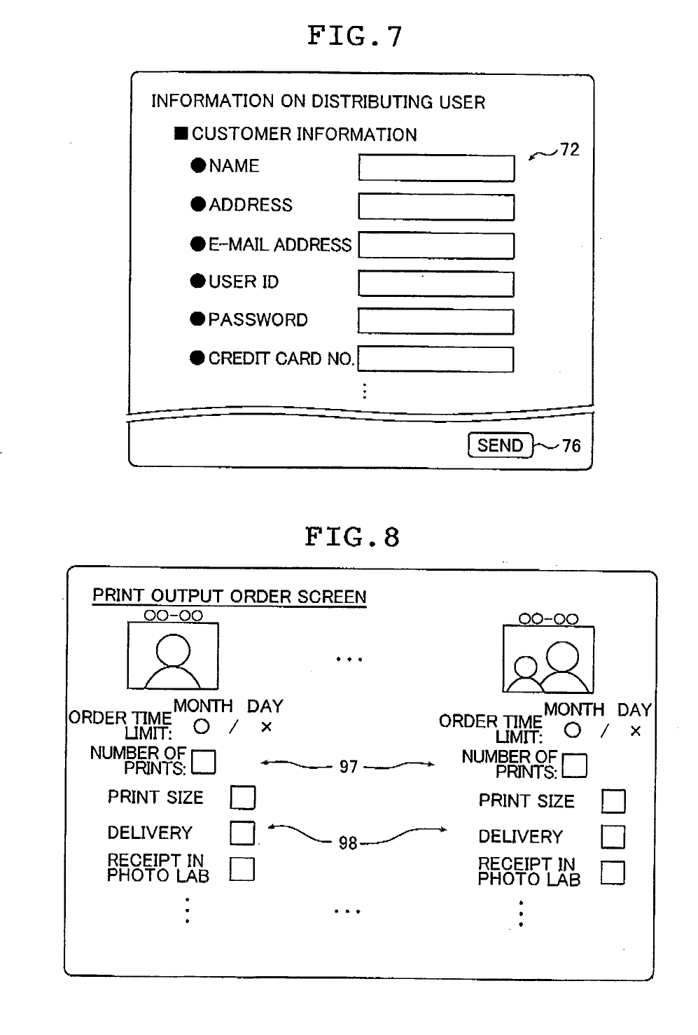

In order to ensure the collection of the service fee, when the payment method is designated, the gift service center 2 requests the image distributing user who is to pay for the service fee to transmit the information on billing (billing information) such as the personal information of the image distributing user, through a screen for inputting information on an image distributing user (see in FIG. 7) represented as required on the display 4a of the image distributing user terminal 4. For example, as shown in FIG. 7, input boxes 72 for inputting personal information such as a name, an address, an e-mail address and a credit card number are displayed. By completing the necessary information in the input boxes 72 and pressing the SEND button 76, predetermined registration information including the billing information is transmitted from the image distributing user terminal 4 to the gift service center 2. The gift service center 2 thus authenticates the billing information of the image distributing user. In other words, the gift service center 2 determines whether or not the collection of the service fee from the image distributing user is possible, based on the input billing information. When the billing information is authenticated, the acceptance means 24 finishes acceptance of the registration information.

When the acceptance of the registration information is finished, the order-related information transmission means 28 issues a time-limited encryption key (hereinafter referred to simply as an encryption key) as print order permission information related to the registration information transmitted from the image distributing user terminal 4, and transmits the order-related information at least including the encryption key to the image distributing user terminal 4 (step S106). As described above, the order-related information includes in advance an image ordering program and the image ID and thumbnail image of a gift image. The order-related information is in the form of electronic file data which can be attached to an e-mail and transmitted to an arbitrary image receiving user terminal 6 specified by the image distributing user terminal 4 by means of the mail application running on the image distributing user terminal 4. Thus, the order-related information can be transmitted by the mail application of the image distributing user terminal 4.

When receiving the order-related information, the image distributing user terminal 4 distributes the order-related information to the image receiving user terminal 6 operated by an arbitrary image receiving user to whom a print of a gift image is to be presented (step S108). A mail application on the personal computer (corresponding to the image distributing user terminal 4) in a home or a firm usually stores the e-mail address of a terminal (corresponding to the image receiving user terminal 6) which is accessed frequently. The order-related information is in the form with which the information can be distributed using the mail application so that the image distributing user can transmit the order-related information to image receiving user terminal 6 without cumbersome work such as inputting of e-mail addresses.

When receiving the order-related information from the image distributing user terminal 4, the image receiving user operates the image receiving user terminal 6 to execute an ordering program. When the ordering program is executed, a print output order screen shown in FIG. 8 is displayed on the display screen on the image receiving user terminal 6. As mentioned above, the order-related information also includes a predetermined image ID and a thumbnail image. The thumbnail images of gift images are presented side by side on the display 6a on the image receiving user terminal 6 by the ordering program as shown in FIG. 8. Each thumbnail image is provided with order information input boxes 97 which allow input of a desired number of prints and a desired size for each image ID. When the thumbnail images are presented side by side, the ordering program is capable of displaying the thumbnail images by performing a predetermined grouping in accordance with the characteristic amounts of the thumbnail images through face recognition or other processing. For example, this function is capable of readily retrieving images of predetermined persons from images where multiple persons are photographed at random.

The upper limit of the number of output prints specified from the image distributing user terminal 4 is displayed for each thumbnail image. The ordering program thus limits the maximum number of output prints that can be ordered. The print delivery method for a print output in accordance with the print output order can also be selected in the check boxes 98. On the image receiving user terminal 6, it is possible to select through the operation by the image receiving user, one of visiting the photo lab to receive an output print and making a delivery company deliver the output print. When the image receiving user wants the delivery by the delivery company, the screen appears to prompt the user to enter predetermined information such as the address and the delivery date, so that the image receiving user operating the image receiving user terminal 6 can set the delivery conditions as desired. The instruction of the delivery method is transmitted to the delivery instruction means 32 of the gift service center 2 as will be described later. When the order-related information is all entered, the ordering program automatically transmits an encryption key and the order information in the form of an e-mail to the order instruction means 30 of the gift service center 2 from the connecting portion 26 of the image receiving user terminal 6 via the Internet 10.

When receiving the encryption key and the order information as an e-mail, the order instruction means 30 checks the encryption key information and automatically determines that the accessing image receiving user terminal 6 has a right to transmit the print output order information, and accepts the order information. In the network print service system of the invention, by transmitting an encryption key as print order permission information, a print output order can be placed from a predetermined user terminal, without any cumbersome work for user registration.

When receiving order information from the image receiving user terminal 6, the order instruction means 30 creates print instruction information in accordance with the order information, searches through the storage means 26 by using the image ID in the order information, calls a corresponding gift image (image data of the original image) from the storage means 26, and transmits the retrieved gift image as well as the print instruction information to the acceptance unit 82 of the photo lab 8. On the photo lab 8, the print 86 is output from the printer 84 in accordance with the print instruction information (step S112).

The output print 86 is delivered to the image receiving user 6 in accordance with the delivery method the image receiving user terminal 6 gave to the delivery instruction means 32 (step S114). When delivery of the print to the image receiving user 6 is finished, the gift service center 2 charges the image distributing user for the service fee based on the payment-related information, in accordance with the order information from the image receiving user, that is, the type and number of prints delivered to the image receiving user and receives payment therefrom.

In the foregoing embodiment, a corresponding gift image is retrieved from the storage means 26 by using the image ID in the order information received by the order instruction means 30 and the gift image is transmitted, together with the print instruction information created in accordance with the order information, to the photo lab 8 (acceptance unit 82). The invention is not limited thereto, but the order instruction means 30 may transmit only the print instruction information including an image ID to the photo lab 8 (acceptance unit 82) and the acceptance unit 82 of the photo lab 8 may access the storage means 26 in the gift center 2 via the Internet 10 to retrieve the corresponding gift image by using the image ID and send the gift image to the printer 84.

In the foregoing embodiment, the order instruction means 30 or the acceptance unit 82 of the photo lab 8 uses an image ID to retrieve a gift image. However, when a thumbnail image is included in the order information, the thumbnail image may be used to retrieve the corresponding image, that is, the original image (image data). In this case, the order information need not include an image ID. When the thumbnail image is included in the order information, the data volume of an e-mail transmitted from the image receiving user terminal 6 to the gift service center 2 is increased. Thus, order information that includes no thumbnail image but an image ID is preferable from the standpoint of the volume of the transmit data. A gift image is more easily retrieved using an image ID than using a thumbnail image. For this reason, order information including an image ID is more preferable than that including only a thumbnail image.

It is preferable that the order information be automatically transmitted to the image distributing user terminal 4 by the ordering program while at the same time being transmitted to the gift service center 2. The image distributing user terminal 4 can preferably check the information on the service fee to be paid from the order information automatically transmitted from the image receiving user terminal 6. When the image distributing user who must pay the service fee accesses order check means (not shown) from the image distributing user terminal 4, the gift service center 2 may allow the image distributing user to check through the image distributing user terminal 4 the print output order information from the image receiving user terminal 6. It is preferable that the image distributing user be capable of instructing the gift service center 2 to change the order information from the image receiving user terminal 6, (to delete order information from a specific image receiving user terminal, for example). It is preferable that, when the order information is transmitted to the gift service center 2, the ordering program be used to automatically receive the print order permission information and delete the order information from the image receiving user terminal 6. It is preferable that a predetermined expiration date be set in the encryption key information and that encryption key information past expiration period be invalid for ordering print output. This configuration enables a false print output order to be previously prevented for example when print authentication information is inadvertently transmitted to a third party. The network print service method of the invention is thus practiced.

The network print service method according to the invention allows a print of an image owned by an image distributing user to be presented as an electronic gift to an image receiving user without increasing the work of the image distributing user. The network print service method also allows the image receiving user who has received an electronic gift from an image distributing user terminal at an image receiving user terminal to access service provision means of a service provider on a network to directly place a print order for a desired image from those owned by the image distributing user and stored on the storage means such as a server and receive the output print, without making cumbersome user registration via the terminal. The network print service method according to the invention is preferable when a user wishes to present an image of image data of his/her own where a large number of persons are photographed such as in a wedding ceremony, to another user as a print, without causing costs or work on the side of the latter.

In this embodiment, a single image distributing user terminal 4 transmits the original image for a gift image as well as the registration information to the gift service center 2, where acceptance at the acceptance means 24 is made, and the image distributing user terminal 4 receives order-related information from the gift service center 2 and distributes to one or more image receiving users 6. In the network print service system and the network print service method of the invention, before issuing print authentication information and the service authentication information, the gift service center 2 previously receives registration information including payment-related information. In case an image receiving user terminal is specified by the image distributing user terminal which has transmitted the registration information to the gift service center 2, it is possible to collect the service fee corresponding to the order information of the order-related information transmitted from the gift service center 2 to the image receiving user terminal. With the network print service system and the network print service method of the invention, as long as registration information as well as the original image for a gift image is transmitted from the image distributing user terminal 4 to ensure collection of the service fee for the gift image from the image distributing user terminal 4, an image distributing user terminal which receives the order-related information is not particularly limited.

For example, the image distributing user terminal may comprise a first image distributing user terminal which transmits the original image for a gift image and the registration information to the gift service center 2 for acceptance at the acceptance means 24, and a second image distributing user terminal which receives order-related information from the gift service center 2 and distributes the information to the image receiving user terminals 6.

In this practice, the second image distributing user terminal may be a terminal specified in the registration information transmitted from the first image distributing user terminal to the service center or a terminal which received service authentication information from the first image distributing user terminal having received the service authentication information from the acceptance means 24 as a result of acceptance of registration information, and which accessed the acceptance means 24 of the service center 2, where the service authentication information was verified. In the network print service system and the network print service method of the invention, the number of image distributing user terminals which transmit the original image for a gift image and the registration information to the gift service center 2 for acceptance at the acceptance means 24 and the number of image distributing user terminals which receive order-related information from the gift service center 2 and distribute the information to the image receiving user terminals 6 are not limited to one.

While the network print service system and the network print service method according to the invention have been detailed hereinabove, the invention is not limited to the foregoing embodiments and various improvements and changes may be made to it without departing from the scope and spirit of the invention.

1. A network print service system comprising:
an image distributing user terminal which transmits image data of at least one first image for providing at least one print as a gift;
at least one image receiving user terminal which transmits order information for ordering at least one print of at least one second image in order to receive said at least one print for free as said gift;
a gift service center which receives said image data of said at least one first image transmitted from said image distributing user terminal and accepts said order information of said at least one print of said at least one second image selected from said at least one first image transmitted from said image receiving user terminal;
print output means which outputs said at least one print of said at least one second image in accordance with said order information accepted in said gift service center; and
print delivery means which delivers said at least one print of said at least one second image output from said print output means to an image receiving user who has transmitted said order information from said image receiving user terminal; wherein
said gift service center comprises:
acceptance means which accepts image data of each original image of said at least one first image to be provided as said gift transmitted from said image distributing user terminal as well as accepts registration information necessary for providing each original image as said gift;
storage means which stores each original image of said at least one first image accepted at said acceptance means from said image distributing user terminal;
order-related information transmission means which transmits, in return for said registration information registered by said acceptance means, order-related information including print order permission information to permit a print order of said at least one first image stored on said storage means to said image distributing user terminal, in a form distributable to said image receiving user terminal;
order instruction means which accepts and verifies said print order permission information transmitted from said image receiving user terminal which has received said order-related information distributed from said image distributing user terminal, accepts said order information of said at least one second image selected from said at least one first image stored on said storage means, and instructs print output of said selected at least one second image according to said order information to said print output means;
delivery instruction means which instructs a delivery method for delivering said at least one print of said at least one second image output by said print output means to said image receiving user; and
billing means which charges said image distributing user with costs of a print gift service including output and delivery of said at least one print of said selected at least one second image in accordance with an order of said image receiving user.

2. The network print service system according to claim 1, wherein
said acceptance means accepts, as said registration information; an upper limit of the number of prints accepted from said image receiving user, a period when said order from said image receiving user is accepted and payment-related information on said costs, and authenticates billing information on said image distributing user in accepting said payment-related information and wherein
said billing means charges said image distributing user with said costs for said print gift service and makes settlement in accordance with said payment-related information and said authenticated billing information.

3. The network print service system according to claim 1, wherein
said order-related information transmission means returns said order-related information to said image distributing user terminal and wherein
said order-related information returned from said gift service center to said image distributing user terminal is transmitted as an e-mail from said image distributing user terminal to said image receiving user terminal of said image receiving user to whom said at least one second image is to be presented as said gift.

4. The network print service system according to claim 1, wherein said order-related information includes a timed-release encryption key, an ordering program, image identification information on said at least one image provided as said gift and a corresponding thumbnail image.

5. The network print service system according to claim 4, wherein said ordering program of said order-related information received as said e-mail from said image distributing user terminal is activated at said image receiving user terminal, wherein order information including selection of a second image to be received as said gift, the number of prints, a print size, and said delivery method is input from an order screen displayed, and said print order is made as an order e-mail by said image receiving user.

6. The network print service system according to claim 5, wherein said ordering program activated at said image receiving user terminal automatically transmits, as said order e-mail, said encryption key, said image identification information and said order information to said gift service center.

7. The network print service system according to claim 5, wherein said ordering program automatically erases said encryption key, once it has automatically transmitted said order e-mail to said gift service center.

8. The network print service system according to claim 5, wherein
said order instruction means of said gift center receives said encryption key, said image identification information and said order information from said image receiving user terminal, accepts said order information where said encryption key and said image identification information are matched, and instructs output of said at least one print of said selected at least one second image according to said order information to said print output means and wherein
said print output means uses said image data of each original image of said at least one first image stored on said storage means to output said at least one print of said selected at least one second image in accordance with said order information.

9. The network print service system according to claim 1, wherein said image distributing user terminal comprises a first image distributing user terminal which transmits said image data of each original image of said at least one first image provided as said gift as well as said registration information to said service center and performs acceptance at said acceptance means and a second image distributing user terminal which receives said order-related information from said gift service center by way of said order-related information transmission means, and distributes said at least one first image to said image receiving user terminal of said image receiving user to whom said at least one second image is to be presented as said gift.

10. The network print service system according to claim 9, wherein said second image distributing user terminal is one specified in said registration information which said first image distributing user terminal transmits to said service center, or one which has received service authentication information from said first image distributing user terminal which has received said service authentication information to authenticate acceptance of said print gift service from said acceptance means by way of acceptance of said registration information, and which has accessed said acceptance means of said service center, where said service authentication information is verified.

11. The network print service system according to claim 9, wherein
said acceptance means accepts, as said registration information, at least an upper limit of the number of prints accepted as said order from said image receiving user and a period when said order is accepted from said image receiving user, wherein said order-related information transmission means accepts said payment-related information on said costs as said registration information when returning said order-related information to said second image distributing user terminal, and authenticates billing information on said second image distributing user in accepting said payment-related information, and wherein
said billing means charges said second image distributing user with said costs for said print gift service and makes settlement in accordance with said payment-related information and said authenticated billing information.

12. A network print service method comprising:
in response to an instruction from a predetermined image distributing user, transmitting image data of each original image of at least one first image to provide at least one print as a gift and registration information necessary for providing at least one first image as said gift from an image distributing user terminal to a gift service center;
in return for said registration information registered, storing on storage means image data of each original image of at least one first image accepted at said gift service center as well as transmitting order-related information including print order permission information to permit a print order of said at least one first image stored on said storage means from said gift service center to said image distributing user terminal, in a form distributable to an image receiving user terminal which can receive said at least one print for free as said gift;
in order to provide said at least one print as said gift, transmitting said order-related information including said print order permission information from said image distributing user terminal to at least one image receiving user terminal;
in order to receive said at least one print for free as said gift, transmitting said print order permission information and order information to order said at least one print for free as said gift of selected at least one second image selected from said at least one first image stored on said storage means from said image receiving user terminal to said gift service center;
accepting and verifying said print order permission information transmitted from said image receiving user terminal, and accepting said order information of said selected at least one second image;
outputting said at least one print of said at least one second image in accordance with said accepted order information;
delivering said at least one print of said output at least one second image from said image receiving user terminal to an image receiving user who has transmitted said order information; and
charging said image distributing user with costs of a print gift service including output and delivery of said at least one print of said selected at least one second image in accordance with said order of said image receiving user.
